(19) United States
(12) Patent Application Publication
(10) Pub. No.: US 2026/0244532 A1
(43) Pub. Date: Aug. 20, 2026

(54) ADJUSTMENT OF ERROR CORRECTION ALGORITHMS

(71) Applicant: Micron Technology, Inc., Boise, ID (US)

(72) Inventors: Anthony D. Veches, Boise, ID (US); Sujeet V. Ayyapureddi, Boise, ID (US); Frank F. Ross, Boise, ID (US); Scott E. Schaefer, Boise, ID (US); Randall J. Rooney, Boise, ID (US); Navid Lashkarian, Pleasanton, CA (US); Matthew A. Prather, Boise, ID (US); Matthew D. Jenkinson, Boise, ID (US)

(21) Appl. No.: 19/537,264

(22) Filed: Feb. 11, 2026

Related U.S. Application Data
(60) Provisional application No. 63/759,982, filed on Feb. 18, 2025.

(51) Int. Cl. G06F 11/10

(52) U.S. Cl. CPC G06F 11/1076

(57) ABSTRACT

Methods, systems, and devices for adjustment of error correction algorithms are described. A memory system may modify an error correction algorithm for different portions of memory within a memory array. For example, the memory system may receive commands to read data from a portion of the memory array, and the memory system may perform error correction of the data using parity information. The memory system may identify that the portion of memory includes a threshold quantity of errors exceeding the error correction capabilities associated with the parity information. In response, the memory system may determine to switch an error correction algorithm for the portion of the data from a first error correction algorithm to a second error correction algorithm. For example, the memory system may store an additional quantity of error correction bits to be used for error correction of the portion of memory during subsequent data accesses.

### CROSS REFERENCE

The present Application for Patent claims priority to U.S. Patent Application No. 63/759,982 by Veches et al., entitled “ADJUSTMENT OF ERROR CORRECTION ALGORITHMS,” filed February 18, 2025, which is assigned to the assignee hereof, and which is expressly incorporated by reference in its entirety herein.

### TECHNICAL FIELD

The following relates to one or more systems for memory, including adjustment of error correction algorithms.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports adjustment of error correction algorithms in accordance with examples as disclosed herein.

FIG. 2 shows an example of a system that supports adjustment of error correction algorithms in accordance with examples as disclosed herein.

FIG. 3 shows an example of a process flow that supports adjustment of error correction algorithms in accordance with examples as disclosed herein.

FIG. 4 shows a block diagram of a memory system that supports adjustment of error correction algorithms in accordance with examples as disclosed herein.

FIGS. 5 and 6 show flowcharts illustrating a method or methods that support adjustment of error correction algorithms in accordance with examples as disclosed herein.

### DETAILED DESCRIPTION

In some memory systems, some portions of a memory array may degrade over time, which may result in errors in the data at the portions of the memory array. In some examples, error correction may be performed by the memory system to mitigate such errors and maintain data integrity. For example, parity information may be stored with data in a memory array to enable error correction of the data. However, in some cases, the parity information may be insufficient to correct the errors in the data, and a threshold quantity of bits may be erroneous after performing the error correction using the parity information. In some cases, the memory system may deactivate (e.g., disable, offload, offline) portions of the data in which errors (e.g., a threshold quantity of errors) persist after performing error correction, which may reduce a capacity of the memory system and waste memory resources. In still other examples, the memory system may read the data with errors, and the errors may render the data unusable in applications associated with high data integrity requirements (e.g., artificial intelligence (AI) applications, among other examples).

In accordance with examples described herein, a memory system may modify an algorithm used for error correction for different portions of a memory array to dynamically balance the error correction complexity with the reliability and accuracy of the stored data. For example, the memory system may receive one or more commands to read data from a portion (e.g., a codeword) of the memory array one or more times during a test operation, for example, and the memory system may perform error correction as part of reading the data using parity information stored with the data. The memory system may identify that the portion of memory includes a threshold quantity of errors that exceeds the error correction capabilities associated with the parity information. In response to the identification of the threshold quantity of errors, the memory system may determine to switch an error correction algorithm for the portion of the data from a first error correction algorithm to a second error correction algorithm. For example, the memory system may store, with the data, an additional quantity of error correction bits (e.g., parity bits) to be used for error correction of the portion of memory during subsequent data accesses. In some other examples, a host system may transmit an indication to the memory system that indicates to switch the error correction algorithm for the portion of the data to the second error correction algorithm, and the memory system may use the second error correction algorithm for subsequent accesses of the portion of the data. In some examples, to switch the error correction algorithm associated with a portion of data from the first error correction algorithm to the second error correction algorithm, the memory system may access the portion of the data from the memory array, decode the portion of the data using the first error correction algorithm, re-encode the portion of the data using the second error correction algorithm, and store the portion of the data encoded using the second error correction algorithm back to the memory array.

In addition to applicability in memory systems as described herein, techniques for adjustment of error correction algorithms may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing the accuracy of data accessed from memory and reducing errors, which may support a high data integrity and increased user experience, among other benefits.

In addition to applicability in memory systems as described herein, techniques for adjustment of error correction algorithms may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by eliminating production processes and supporting an increased usability and shelf life of memory products over time, which may result in lowering production emissions, reducing electronic waste, and extending the life of electronic devices, thereby reducing electronic waste, among other benefits.

Features of the disclosure are illustrated and described in the context of systems. Features of the disclosure are further illustrated and described in the context of process flows, block diagrams, and flowcharts.

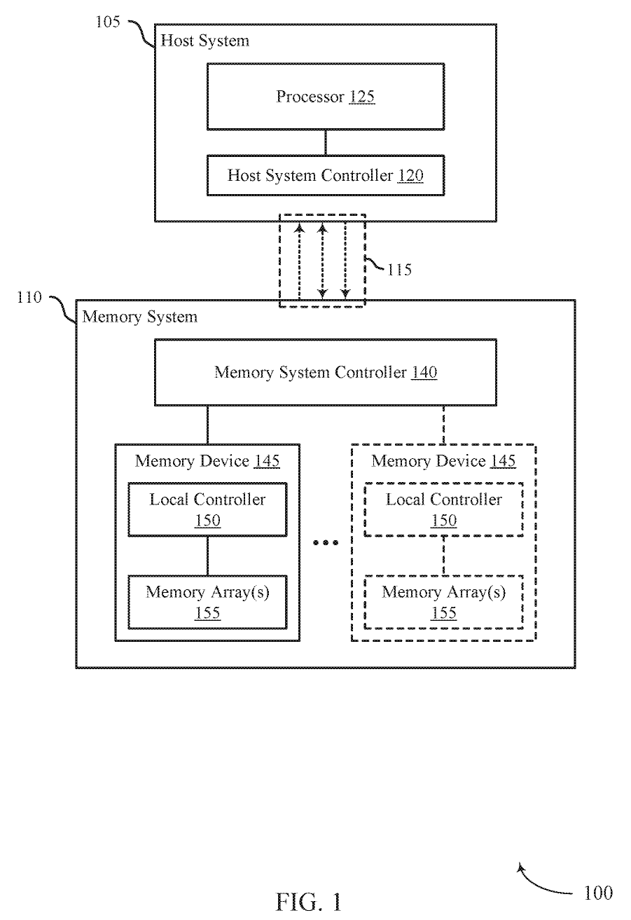

FIG. 1 illustrates an example of a system 100 that supports adjustment of error correction algorithms in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105 and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some memory systems 110, some portions of a memory array 155 in a memory device 145 may degrade over time, which may result in errors in the data at the portions of the memory array 155. In some examples, error correction may be performed by the memory system to mitigate such errors and maintain data integrity. For example, parity information may be stored with data in a memory array 155 to enable error correction of the data. However, in some cases, the parity information may be insufficient to correct the errors in the data, and a threshold quantity of bits may be erroneous after performing the error correction using the parity information. In some cases, the memory system may deactivate (e.g., disable, offload, offline) portions of the data in which errors (e.g., a threshold quantity of errors) persist after performing error correction, which may reduce a capacity of the memory system 110 and waste memory resources. In still other examples, the memory system may read the data with errors, and the errors may render the data unusable in applications associated with high data integrity requirements (e.g., AI applications).

In accordance with examples described herein, a memory system 110 may modify the error correction algorithm for different portions of memory (e.g., codewords) within a memory array 155. For example, the memory system 110 may receive one or more commands to read data from a portion (e.g., a codeword) of the memory array 155, and the memory system 110 may perform error correction as part of reading the data using parity information stored with the data. The memory system 110 may identify that the portion of memory includes a threshold quantity of errors that exceeds the error correction capabilities associated with the parity information. In response to the identification of the threshold quantity of errors, the memory system 110 may determine to switch an error correction algorithm for the portion of the data from a first error correction algorithm to a second error correction algorithm. For example, the memory system 110 may store, with the data, an additional quantity of error correction bits (e.g., parity bits) to be used for error correction of the portion of memory during subsequent data accesses. In some other examples, a host system 105 may transmit an indication to the memory system 110 that indicates to switch the error correction algorithm for the portion of the data to the second error correction algorithm, and the memory system 110 may use the second error correction algorithm for subsequent accesses of the portion of the data.

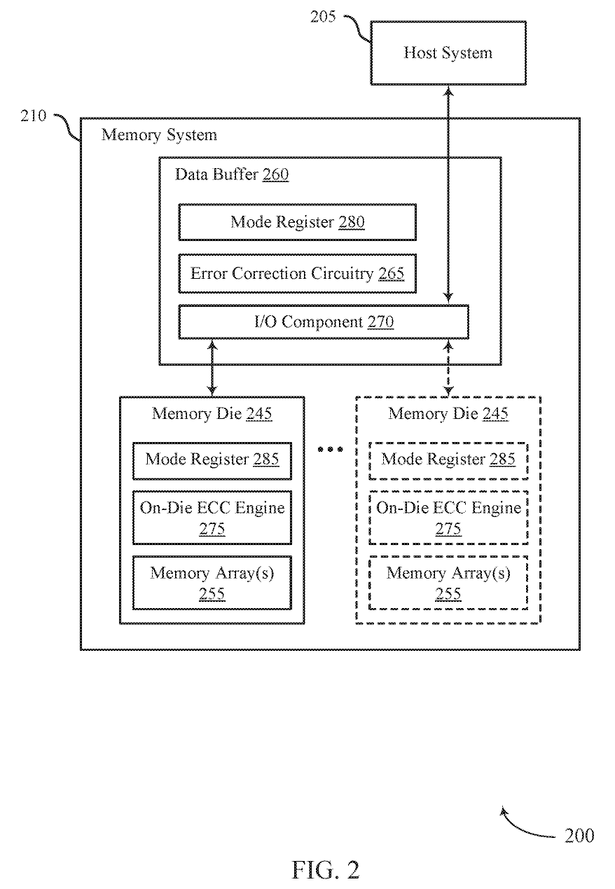

FIG. 2 illustrates an example of a system 200 that supports data buffer error correction functionality in accordance with examples as disclosed herein. The system 200 represent an example of a system 100 or one or more components thereof. As described herein, the system 200 may include a memory system 210 that supports system-level (e.g., module-level) error correction within a data buffer 260 before data is conveyed to a host system 205. The memory system 210 and the host system 205 may represent examples of corresponding systems as described herein, including with reference to FIG. 1.

The memory system 210 may represent an example of a module including one or more memory dies 245, which may represent examples of the memory devices 145 described with reference to FIG. 1. Each of the memory dies 245 may include one or more memory arrays 255 configured to store data, parity bits, metadata, or the like. In some examples, each of the memory dies 245 may also include a respective on-die ECC engine 275, which may represent an example of error correction circuitry configured to detect errors, correct errors, or both within the data stored to the memory arrays 255 of the memory die 245.

The memory system 210 may include a memory system controller 140, as described and illustrated with reference to FIG. 1. In this example, the memory system 210 may additionally include the data buffer 260. The data buffer 260 may be coupled with the memory system controller 140, in some examples, and may be configured to transfer and buffer data between the host system 205 and the memory dies 245. All data that enters the memory system 210 from the host system 205 or that is transferred to the host system 205 from the memory system 210 may be transferred through the data buffer 260. For example, the data buffer 260 may include or otherwise be coupled with an I/O component 270 configured to facilitate the transfer of data to and from the memory system 210 via one or more channels, such as the one or more channels 115 described with reference to FIG. 1 (e.g., a link). The data buffer 260 may thereby be the point where all data leaving the memory system 210 to the host system 205 (e.g., system on chip (SoC)) passes through.

Techniques described herein provide for a system-level error correction functionality within the data buffer 260. That is, the data may be corrected at a system level within the data buffer 260 before the data is transferred to the host system 205, which may improve performance, in some examples. For example, transferring the parity bits from one or more of the memory dies 245 configured to store parity information to the data buffer 260 may consume less power and overhead than transferring the parity bits off of the memory system 210 to the host system 205. Shipping the extra bits (e.g., 80 extra parity bits, or some other quantity) to the host system 205 may increase energy and overhead. Additionally, or alternatively, exposing the parity bits outside of the memory system 210 may pose security risks. Since the data buffer 260 is local to the memory system 210, the energy expended to move the extra bits may be less than energy to ship the bits to the host system 205, and security within the memory system 210 may be maintained.

Thus, as described herein, the data buffer 260 may receive, in response to a read command, data from one or more of the memory dies 245, as well as one or more parity bits from the parity memory dies 245 (e.g., the memory dies 245 that only store parity information). The data buffer 260 may include the error correction circuitry 265, which may be configured to perform an error detection and correction operation on the data using the parity bits. The error detection and correction operation may be performed in accordance with one or more different algorithms or techniques. For example, the error correction circuitry 265 may include one or more logic components configured to support (e.g., execute) error correction code (ECC), error-detecting code (EDC), other algorithms, or any combination thereof. The I/O component 270 within the data buffer 260 may send the corrected data to the host system 205 after the error correction is performed. In some examples, the I/O component 270 may transfer one or more bits of metadata with the data to indicate that system-level error correction was performed, to indicate whether the errors were corrected or not, to indicate an address of the data, or other information associated with the data. The host system 205 may thereby receive the data with an indication of where error correction was performed and may determine how to address any potential errors the host system 205 may detect accordingly. It may be beneficial to have all correction capability in the buffer using all of the parity bits retrieved from the memory dies 245. Such system-level error correction may be performed in addition to the on-die error correction, in some examples.

Additionally, or alternatively, techniques described herein may provide for one or more of the on-die ECC engines to be turned off or otherwise disabled, such that the extra parity bits within each memory die 245 may be transferred to the data buffer 260 to enhance the system-level error correction. For example, each memory die 245 may include one or more mode registers 285 configured to indicate whether on-die error correction is enabled or disabled.

If the on-die error correction is disabled at one or more of the memory dies 245, those memory dies may be configured to transfer extra on-die parity bits stored at the memory dies 245 to the data buffer 260. For example, when a read command is received, a memory die 245 may retrieve the requested data and transfer the requested data in addition to one or more of the on-die parity bits to the data buffer 260. The data buffer 260 may use the extra parity bits to perform, by the error correction circuitry 265, the error detection and correction operations. The extra bits (e.g., eight bits from each memory die 245, or 16 bits from each memory die 245, for example) may improve an accuracy and reliability of the system-level error correction. For example, the error correction circuitry 265 may be able to detect and correct an increased quantity of errors with the increased quantity of parity bits. In some examples, if the detection capabilities of the error correction circuitry 265 are increased, the error correction circuitry 265 may detect one or more errors that the error correction circuitry 265 may not be capable of correcting. In such cases, the error correction circuitry 265 may send the data, along with metadata, to the host system 205, where the metadata may indicate that there are uncorrected errors.

By transferring and aggregating all of the parity bits within the memory system 210 at the data buffer 260, the data buffer 260 and error correction circuitry 265 within the data buffer 260 may support error correction for larger portions of data at a time. For example, if an entire memory die 245 is corrupted or otherwise goes down, the increased quantity of parity bits may facilitate reconstruction and correction of the whole memory die 245 by the error correction circuitry 265 at the system level (e.g., chip kill may be replicated in the data buffer 260).

The system-level error correction may be changed dynamically or prior to deployment of the memory system 210. For example, the memory dies 245 may each include a respective mode register 285 that may be set to a certain value during manufacture of the memory system 210, or dynamically throughout operation of the memory system 210. A value of the mode registers 285 may indicate an error correction mode of the memory dies 245 selected from multiple candidate error correction modes. A first value of the mode register 285 may indicate that on-die error correction is enabled, and a second value of the mode register 285 may indicate that on-die error correction is disabled. In some examples, one or more other values may indicate some intermediate level of error correction. The data buffer 260 may similarly include or otherwise be coupled with a mode register 280, which may be configured to indicate whether system-level error correction is enabled or not. A value of the mode register 280 may indicate an error correction mode of the data buffer 260 selected from multiple candidate error correction modes (e.g., enabled, disabled, partially enabled, varying levels of complexity, and the like). The mode registers 280 and 285 may be set by a memory system controller 140, in some examples. Additionally, or alternatively, the memory system 210 might receive some signaling or other indication from the host system 205 indicating the values for the mode registers 280 and 285. In some examples, a user of the system may input the requested mode register values based on a use case of the user or other parameters. Additionally, or alternatively, the allocation of on-die versus system-level error correction may be made during manufacture of the system 200.

In some examples, the error correction circuitry 265 within the data buffer 260 may include one or more logic gates or other components configured to perform varying levels of error correction. For example, the error correction circuitry 265 may support error correction in accordance with a first algorithm and a first quantity of parity bits when on-die error correction is enabled and system-level error correction is enabled using parity bits from one or more dies configured to store only parity information. Additionally, or alternatively, if system-level error correction is disabled, the error correction circuitry 265 may refrain from performing any error correction or detection on the data before transferring the data to the host system 205. If on-die error correction is disabled and system-level error correction is enabled, the error correction circuitry 265 may support error correction in accordance with a second algorithm and a second quantity of parity bits that may be greater than the first quantity. The second algorithm may be more complex and may be capable of correcting more errors per codeword than the first algorithm, in some examples. The logic within the error correction circuitry 265 may similarly support one or more other error correction algorithms based on a value of the mode register(s) 280 and a quantity of parity bits that are available. The data buffer 260 may thereby use a logic process for error correction instead of a DRAM process, or other type of process, which may improve performance of the error correction as compared with only on-die error correction or host-level error correction.

In some examples, the memory system 210 may be configured to adjust the error correction algorithm (e.g., to the first error correction algorithm, to the second error correction algorithm, etc.) for different portions of data stored in the memory arrays 255, based on a configuration of the memory system 210, based on one or more conditions of the memory system 210, or both. For example, an error correction algorithm may be selected from a set of pre-defined error correction algorithms (e.g., a set of candidate H-matrices) for performing error correction on the different portions of data as the data is retrieved from the memory arrays 255 and transferred to the data buffer 260 for system-level error correction. The selection of the error correction algorithm may be based on metadata (e.g., parity information) stored with the data (e.g., the different portions of data) in the memory arrays 255.

In a first example, the memory system 210 may, during operation of the memory system 210 (e.g., based on receiving multiple read commands from the host system 205 to a portion of memory), determine that a quantity of errors at a portion of memory (e.g., at one or more codewords, at one or more columns, at one or more dies 245) satisfies a threshold and/or may identify portions of memory that are failing (e.g., failing to meet performance criteria, failing to meet data accuracy thresholds, etc.). In such examples, the memory system 210 may adjust error correction algorithms (e.g., select an error correction algorithm from a set of candidate error correction algorithms) for the identified portions of memory to increase an accuracy of data retrieved from the portions of memory (e.g., instead of offloading or deactivating the memory).

In a second example, the memory system 210 may, according to a profiling cycle, periodically profile the memory system to determine portions of memory within the memory arrays 255 that would benefit from increased error correction capability. For example, during a profiling duration (e.g., during a test operation), the memory system may receive commands from a host system 205 to read data from the memory arrays 255 and may identify portions of memory (e.g., codewords, columns, dies) that are being read with a threshold quantity of errors and/or that are associated with a high data integrity requirement or application (e.g., AI application). Based on performing the profiling of the memory system over time, the memory system 210 may determine to adjust error correction algorithms (e.g., select an error correction algorithm from a set of candidate error correction algorithms) for the identified portions memory to increase an accuracy of data retrieved from the portions of memory.

The error correction algorithm may correspond to a type of error correction code that is used, a quantity of parity bits used for error correction, an H-matrix associated with the error correction, logic circuitry for error correction, or any combination thereof. For example, the error correction circuitry 265 in the data buffer 260 may include one or more logic gates and components configured to perform error correction. As the complexity of the error correction algorithm increases, more of the logic gates may be activated and used for enhanced error correction. One or more of the logic gates may be deactivated for error correction according to a reduced error correction algorithm. The quantity of logic gates may correspond to or otherwise be based on a size of an H-matrix associated with the error correction algorithm, in some examples. The data buffer 260 may thereby be configured with the error correction circuitry 265 to support dynamic and varying levels of error correction during operation of the memory system 210.

Although the system-level error correction is described herein as being performed within the data buffer 260, it is to be understood that, in some examples, the system-level error correction may be performed by anyone or more components within the memory system 210 that are external to or distributed across the one or more memory dies 245. In any case, the error correction performed at the system level may vary dynamically in complexity based on the error correction algorithm selection techniques described herein.

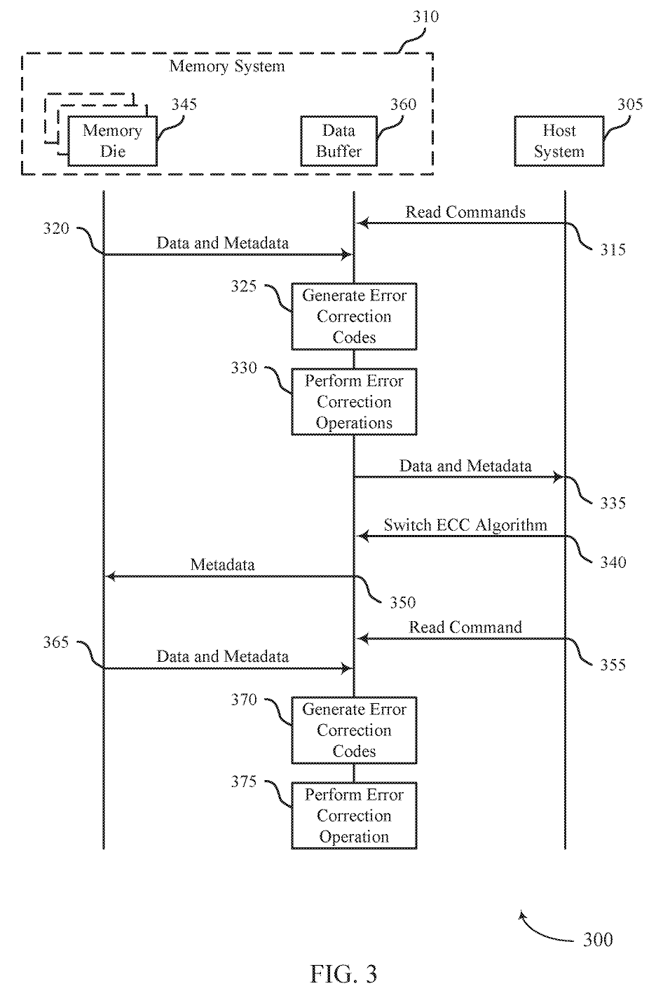

FIG. 3 shows an example of a process flow 300 that supports adjustment of error correction algorithms in accordance with examples as disclosed herein. The process flow 300 may implement or be implemented by aspects of the system 100 or the system 200, as described with reference to FIGS. 1 and 2. For example, the process flow 300 illustrates exchanges of data and metadata between one or more memory dies 345 and a data buffer 360 within a memory system 310, and between the memory system 310 and a host system 305, which may represent examples of corresponding systems and dies as described with reference to FIGS. 1 and 2. In this example, the data buffer 360 may include error correction capabilities for correcting errors at the system-level prior to transferring data to the host system 305.

At 315, the host system 305 may transmit multiple read commands to the memory system 310 via a link (e.g., one or more channels) between the host system 305 and the memory system 210. The multiple read commands may be received by one or more components within the memory system 310, including, in some examples, the data buffer 360, or other components. In some examples, the multiple read commands may be received during a duration associated with a profiling of the memory system. For example, the memory system 310 may receive the multiple read commands as part of a test operation or profiling operation, which may occur during bootup of the memory system and/or may repeat according to a preconfigured profiling cycle. The multiple read commands may include multiple reads to a same portion of data within the memory dies 345.

At 320, in response to one or more of the multiple read commands, the memory system 310 may retrieve the requested data from one or more memory dies 345. The memory dies 345 may transfer the data to the data buffer 360. If on-die error correction is enabled, the on-die error correction circuitry at the one or more memory dies 345 may correct one or more errors in the data before transferring the data to the data buffer 360. If on-die error correction is disabled, the one or more memory dies 345 may transfer the data and one or more parity bits (e.g., metadata) along with the data. The one or more parity bits may be allocated for on-die error correction, and may be transferred to the data buffer 360 for use in the system-level error correction, as described with reference to FIG. 2. The parity bits may represent examples of one or more additional bits that are separate from the data (e.g., different from, do not include the data).

The one or more parity bits may, in some examples, indicate a default error correction algorithm for performing the system-level correction, which may be associated with lower error correction capabilities relative to other error correction algorithms supported by the memory system 310. In some examples, the default error correction algorithm may be indicated by the host system 305 (e.g., via one or more messages received at the data buffer 360) or may be indicated by mode registers of the memory system (e.g., the mode register 285, the mode register 280 illustrated in FIG. 2). In some examples, the default error correction algorithm may be a Reed-Solomon error correction algorithm, or some other type of error correction.

At 325, the error correction circuitry within the data buffer 360 of the memory system 310 may generate, based on the data indicated via the write command, one or more error correction codes (e.g., parity information) associated with the data. The data buffer 360 may generate the error correction codes based on a mode of the data buffer 360 indicating that system-level error correction is supported, in some examples. The data buffer 360 may generate the error correction codes according to a first error correction algorithm (e.g., a default error correction algorithm) based on a quantity of parity bits that the data buffer 360 retrieved from the memory dies 345.

At 330, the memory system 310 (e.g., the data buffer 360) may perform error correction operations on the data retrieved from the memory dies 345 according to the first error correction algorithm (e.g., the default error correction algorithm) and using the parity information retrieved from the memory dies 345. For example, the error correction circuitry within the data buffer 360 may use one or more algorithms and corresponding logic gates to correct the errors. The error correction may be performed using the default error correction algorithm (e.g., ECC, EDC, hamming codes, Reed-Solomon codes, any other error correction codes, or any combination thereof).

Based on performing the error correction operations according to the first error correction algorithm, the memory system 310 may detect a respective quantity of errors for each portion of data (e.g., codeword) of multiple portions of data retrieved from the memory die 345. In some examples, the memory system may determine a respective quantity of errors for each column access, for each row access, etc. In some examples, the memory system 310 may correct a first quantity of errors based on performing the error correction operations, and a second quantity of errors may be left uncorrected based on a capability associated with the first error correction algorithm, a quantity of parity bits retrieved from the memory dies 345, or both.

The memory system 310 may determine, based on the quantity of errors detected for each portion of data of the multiple portions of data, that the parity information (e.g., metadata) retrieved from the memory dies 345 corresponding to the portion of data is insufficient for performing error correction. For example, the memory system 310 may determine that performing the error correction using the first error correction algorithm (e.g., a first quantity of parity bits included in the parity information) results in a threshold quantity of errors remaining, leftover, or uncorrected, after the error correction operation is performed. Additionally, or alternatively, the memory system 310 may determine that the quantity of errors detected for the portion of data satisfies a threshold quantity of errors that exceeds a capability of error correction using the retrieved parity information. In some examples, the memory system 310 may determine that additional parity information (e.g., additional error correction bits, additional parity bits) may be stored to the memory dies 345 to increase the accuracy of error correction operations for subsequent accesses of the portion of data.

At 335, the data buffer may transfer, via an interface between the data buffer 360 and the host system 305 (e.g., the one or more channels 115), the data and metadata associated with the portions of the data. The data buffer 360 may transfer the data based on detecting and/or correcting the one or more errors in the data and in response to the read command. The metadata may, in some examples, indicate whether there are any uncorrected errors in the data. Additionally, or alternatively, the metadata may indicate whether the system-level error correction was performed, one or more addresses associated with errored data, or the like.

At 340, in some examples, the host system 305 may transmit, to the memory system 310, an indication to switch portions of data (e.g., codewords) from a first error correction algorithm to one or more second error correction algorithms. The indication from the host system 305 may indicate a respective error correction algorithm assigned to each of the multiple portions of the data and may indicate to switch each portion of the data from the default error correction algorithm to the respective second error correction algorithm. The indication from the host system 305 may be based on a presence of uncorrected errors (e.g., or a threshold quantity of errors) in the indicated portions of the data. Additionally, or alternatively, the indication from the host system 305 may be based on a characteristic of the portions of the data or one or more applications or requirements associated with the portions of the data (e.g., data integrity requirements, AI applications, latency tolerant applications). In some examples, the host system 305 may indicate an address corresponding to the portions of data (e.g., codewords) for which the respective second error correction algorithm is to be applied or switched to.

Additionally, or alternatively, the memory system 310 (e.g., a memory system controller) may determine to switch the error correction algorithm for one or more portions of the data based on a quantity of errors detected in the portions of the data and with or without any indication from the host system 305. For example, the memory system 310 may identify, at 330, one or more portions of data associated with a threshold quantity of uncorrected errors, and the memory system 310 may determine to increase an error correction algorithm for the identified portions.

At 350, the memory system 310 (e.g., the data buffer 360) may store metadata with the portions of data identified (e.g., at 330) or indicated by the host system 305 (e.g., at 340) that indicates a switch from the first error correction algorithm previously used for performing error correction on the portions of data to one or more second error correction algorithms to be used for subsequent access operations (e.g., and error correction operations) for the portions of data. The metadata stored with each portion of the data may indicate different error correction algorithms for respective portions of the data. For example, the memory system 310 may store first metadata with a first portion of data (e.g., a first codeword) that indicates a second error correction algorithm (e.g., corresponding to a first error correction capability) and may store second metadata with a second portion of data (e.g., a second codeword) that indicates a third error correction algorithm (e.g., corresponding to a second error correction capability greater than the first error correction capability).

In some examples, the error correction algorithm for a given portion of data may be an example of a key for accessing the portion of the data. For example, once data is written in accordance with a certain error correction algorithm, the data may not be read using any other error correction algorithm. Thus, to switch the error correction algorithm associated with a portion of data from the first error correction algorithm to the second error correction algorithm, the memory system 310 (e.g., the data buffer 360) may read (e.g., perform an internal read of) the portion of the data from the memory die 345 and decode the portion of the data using the first error correction algorithm (e.g., using error correction circuitry at the data buffer 360). After decoding the portion of the data with the first error correction algorithm, the memory system 310 (e.g., the data buffer 360) may encode (e.g., re-encode) the portion of the data using the second error correction algorithm and write (e.g., store) the portion of the data encoded using the second error correction algorithm back to the memory die 345. Subsequent accesses of the portion of the data (e.g., after the switch from the first error correction algorithm to the second error correction algorithm) may include reading (e.g., performing an internal read of) the portion of the data from the memory die 345 and decoding the portion of the data using the second error correction algorithm.

In some examples, storing the metadata may include storing an additional quantity of one or more parity bits with a first quantity of parity bits to increase a strength of the error correction algorithm corresponding to the portion of data. For example, error correction according to the first error correction algorithm may use a first quantity of parity bits and error correction according to the second error correction algorithm may use a second quantity of parity bits greater than the first quantity of bits. In some examples, the memory system 310 may transmit an indication to the host system 305 that the data buffer 360 is utilizing or storing a greater quantity of parity bits (e.g., one extra bit, more than one extra bits) for performing error correction on the portion of data. In some cases, storing the additional bits for parity information may overwrite or replace different metadata that is stored at the memory dies 345. Additionally, or alternatively, the one or more additional bits may be pulled from one or more memory dies 345 configured for storing parity information or from one or more memory dies 345 associated with disabled on-die error correction, or the like.

The one or more second error correction algorithms may correspond to greater error correction strength or more error correction capability relative to the first error correction algorithm (e.g., the default error correction algorithm). For example, the second error correction algorithms may have a capability for correcting a greater quantity of errors relative to the first error correction algorithm. In some examples, the first error correction algorithm may have a capability to perform error correction on single bits at a time (e.g., single bit correction), while the second error correction algorithms may have a capability to correct sets of two or more bits at a time (e.g., dual bit correction, triple bit correction, etc.).

At 355, the host system 305 may transmit a read command to the memory system 310 via the link between the host system 305 and the memory system 310. The read command may indicate one or more addresses associated with the metadata stored at 350. That is, the host system 305 may request to read at least one portion of data (e.g., codeword) for which the error correction algorithm has been switched.

At 365, in response to the read command, the memory system 310 may retrieve the requested data from one or more memory dies 345. The memory dies 345 may transfer the data and one or more parity bits (e.g., metadata) along with the data to the data buffer 360. The parity bits may be allocated for on-die error correction according to second error correction algorithms that portions of the read data (e.g., codewords) have been switched to. The parity bits may be transferred to the data buffer 360 for use in the system-level error correction, as described with reference to FIG. 2.

At 370, the data buffer 360 may generate second error correction codes for the data based on the parity bits retrieved with the data. For example, the error correction circuitry within the data buffer 360 may generate the second error correction codes using second error correction algorithms different from the first error correction algorithm used to generate the error correction codes at 325. The error correction circuitry may generate different error correction codes for each portion of data (e.g., codeword) retrieved from the memory dies 345 in accordance with the parity bits indicating respective error correction algorithms for each portion of data.

At 375, the memory system 310 (e.g., the data buffer 360) may perform error correction operations on the data retrieved from the memory dies 345 according to the second error correction algorithms and using the updated parity information (e.g., additional parity bits) retrieved from the memory dies 345. For example, the error correction circuitry within the data buffer 360 may use one or more algorithms and corresponding logic gates to correct the errors. The error correction may be performed using ECC, EDC, hamming codes, Reed-Solomon codes, any other error correction codes, or any combination thereof.

The memory system 310 described herein may thereby support dynamically configurable error correction algorithms for performing system-level error correction on each codeword retrieved from memory dies 345 during memory access, which may improve reliability and accuracy of data accesses performed by the memory system 310, among other benefits.

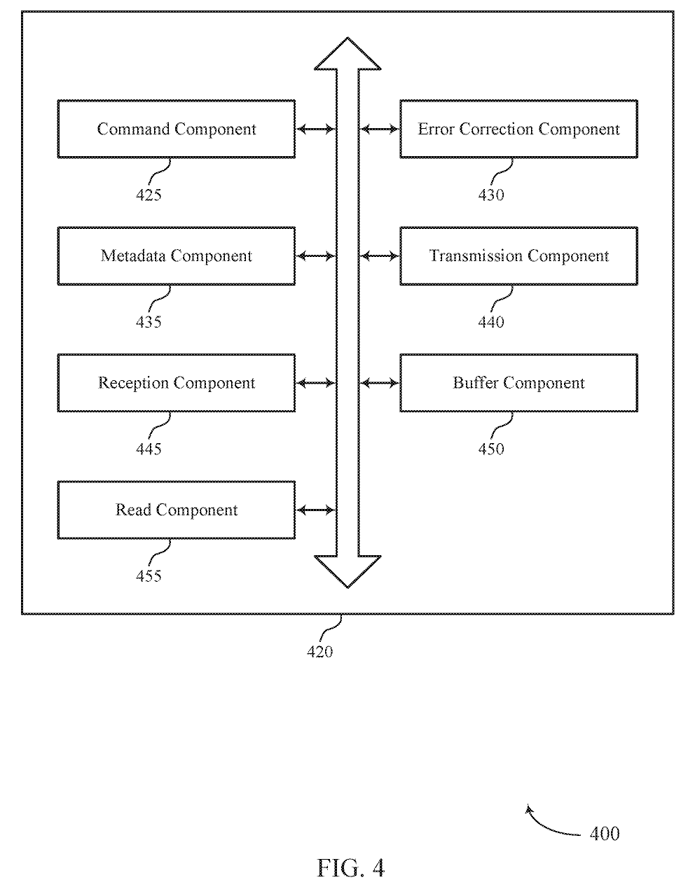

FIG. 4 shows a block diagram 400 of a memory system 420 that supports adjustment of error correction algorithms in accordance with examples as disclosed herein. The memory system 420 may be an example of aspects of a memory system as described with reference to FIGS. 1 through 3. The memory system 420, or various components thereof, may be an example of means for performing various aspects of adjustment of error correction algorithms as described herein. For example, the memory system 420 may include a command component 425, an error correction component 430, a metadata component 435, a transmission component 440, a reception component 445, a buffer component 450, a read component 455, or any combination thereof. Each of these components, or components of subcomponents thereof (e.g., one or more processors, one or more memories), may communicate, directly or indirectly, with one another (e.g., via one or more buses).

The command component 425 may be configured as or otherwise support a means for receiving a plurality of read commands associated with data stored in a plurality of memory arrays of the memory system. The error correction component 430 may be configured as or otherwise support a means for performing, based at least in part on the plurality of read commands and according to a first error correction algorithm, one or more error correction operations on the data. The metadata component 435 may be configured as or otherwise support a means for storing, based at least in part on a quantity of errors associated with one or more portions of the data detected during the one or more error correction operations being greater than a threshold, metadata that indicates a change from the first error correction algorithm used for the one or more error correction operations to a second error correction algorithm to be used for subsequent access operations associated with the one or more portions of the data.

In some examples, the buffer component 450 may be configured as or otherwise support a means for transferring, based at least in part on the plurality of read commands, the data from the plurality of memory arrays to a buffer of the memory system, the buffer including error correction circuitry for system-level error correction. In some examples, the error correction component 430 may be configured as or otherwise support a means for performing, by the buffer and using the error correction circuitry, the one or more error correction operations on the data transferred to the buffer.

In some examples, the error correction component 430 may be configured as or otherwise support a means for determining, based at least in part on performing the one or more error correction operations, a respective quantity of errors associated with each codeword of a plurality of codewords associated with the data. In some examples, the metadata component 435 may be configured as or otherwise support a means for storing, based at least in part on determining the respective quantity of errors associated with each codeword of the plurality of codewords, second metadata, for each codeword of the plurality of codewords, that indicates whether to maintain the first error correction algorithm for subsequent access operations associated with the plurality of codewords.

In some examples, the error correction component 430 may be configured as or otherwise support a means for determining, based at least in part on performing the one or more error correction operations, the quantity of errors associated with the one or more portions of the data, where the one or more portions of the data include one or more codewords associated with the data, where storing the metadata that indicates the change from the first error correction algorithm to the second error correction algorithm for the one or more portions of the data is based at least in part on determining that the quantity of errors associated with each codeword of the one or more codewords is greater than the threshold.

In some examples, the metadata component 435 may be configured as or otherwise support a means for storing, based at least in part on a second quantity of errors associated with one or more second portions of the data detected during the one or more error correction operations being greater than a second threshold, second metadata that indicates a second change from the first error correction algorithm used for the one or more error correction operations to a third error correction algorithm to be used for subsequent access operations associated with the one or more second portions of the data, where the third error correction algorithm is associated with more error correction capabilities than the first error correction algorithm and the second error correction algorithm.

In some examples, the threshold is based at least in part on a first quantity of errors that the first error correction algorithm is capable of correcting within a given portion of data. In some examples, the second error correction algorithm is capable of correcting a second quantity of errors within a given portion of data, the second quantity being greater than the first quantity based at least in part on one or more additional parity bits associated with the second error correction algorithm.

In some examples, to support storing the metadata that indicates the change from the first error correction algorithm to the second error correction algorithm, the metadata component 435 may be configured as or otherwise support a means for storing one or more additional parity bits with a first quantity of parity bits associated with the first error correction algorithm, where the second error correction algorithm is associated with a second quantity of parity bits greater than the first quantity of parity bits.

In some examples, the command component 425 may be configured as or otherwise support a means for receiving, after storing the metadata, a read command for at least one portion of the one or more portions of the data. In some examples, the read component 455 may be configured as or otherwise support a means for retrieving from one or more memory arrays of the plurality of memory arrays of the memory system based at least in part on the read command, the at least one portion of the data and the metadata. In some examples, the error correction component 430 may be configured as or otherwise support a means for performing, based at least in part on the metadata, an error correction operation on the at least one portion of the data according to the second error correction algorithm.

In some examples, to support receiving the plurality of read commands, the command component 425 may be configured as or otherwise support a means for receiving the plurality of read commands during a duration associated with a profiling of the memory system, where storing the metadata that indicates the change from the first error correction algorithm to the second error correction algorithm is based at least in part on the duration associated with the profiling of the memory system.

In some examples, the command component 425 may be configured as or otherwise support a means for receiving a plurality of read commands associated with data stored in a plurality of memory arrays of the memory system. In some examples, the error correction component 430 may be configured as or otherwise support a means for performing, based at least in part on the plurality of read commands and according to a first error correction algorithm, one or more error correction operations on the data. The transmission component 440 may be configured as or otherwise support a means for transmitting, based at least in part on performing the one or more error correction operations on the data according to the first error correction algorithm, the data to a host system. The reception component 445 may be configured as or otherwise support a means for receiving, from the host system based at least in part on transmitting the data, an indication to switch an error correction algorithm associated with one or more portions of the data from the first error correction algorithm to a second error correction algorithm. In some examples, the metadata component 435 may be configured as or otherwise support a means for storing, based at least in part on the indication from the host system, metadata that indicates the switch in the error correction algorithm associated with the one or more portions of the data from the first error correction algorithm used for the one or more error correction operations to the second error correction algorithm to be used for subsequent access operations associated with the one or more portions of the data.

In some examples, the buffer component 450 may be configured as or otherwise support a means for transferring, based at least in part on the plurality of read commands, the data from the plurality of memory arrays to a buffer of the memory system, the buffer including error correction circuitry for system-level error correction. In some examples, the error correction component 430 may be configured as or otherwise support a means for performing, by the buffer and using the error correction circuitry, the one or more error correction operations on the data transferred to the buffer.

In some examples, the reception component 445 may be configured as or otherwise support a means for receiving, from the host system based at least in part on transmitting the data, a second indication to switch an error correction algorithm associated with one or more second portions of the data from the first error correction algorithm to a third error correction algorithm. In some examples, the metadata component 435 may be configured as or otherwise support a means for storing, based at least in part on the second indication from the host system, second metadata that indicates the switch from the first error correction algorithm used for the one or more error correction operations to the third error correction algorithm to be used for subsequent access operations associated with the one or more second portions of the data, where the third error correction algorithm is associated with more error correction capabilities than the first error correction algorithm and the second error correction algorithm.

In some examples, to support storing the metadata that indicates the switch in the error correction algorithm associated with the one or more portions of the data, the metadata component 435 may be configured as or otherwise support a means for storing one or more additional parity bits with a first quantity of parity bits associated with the first error correction algorithm, where the second error correction algorithm is associated with a second quantity of parity bits greater than the first quantity of parity bits.

In some examples, the command component 425 may be configured as or otherwise support a means for receiving, after storing the metadata, a read command for at least one portion of the one or more portions of the data. In some examples, the read component 455 may be configured as or otherwise support a means for retrieving from one or more memory arrays of the plurality of memory arrays of the memory system based at least in part on the read command, the at least one portion of the data and the metadata. In some examples, the error correction component 430 may be configured as or otherwise support a means for performing, based at least in part on the metadata, an error correction operation on the at least one portion of the data according to the second error correction algorithm.

In some examples, to support receiving the plurality of read commands, the command component 425 may be configured as or otherwise support a means for receiving the plurality of read commands during a duration associated with a profiling of the memory system, where storing the metadata that indicates the switch from the first error correction algorithm to the second error correction algorithm is based at least in part on the duration associated with the profiling of the memory system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

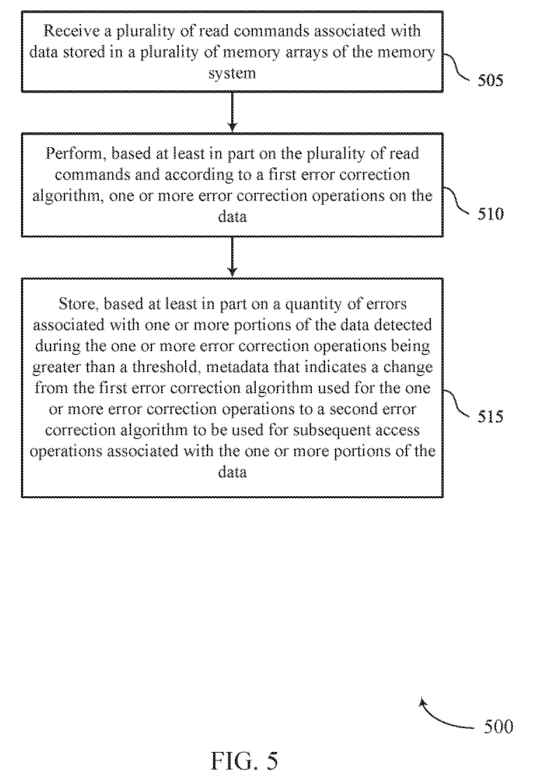

FIG. 5 shows a flowchart illustrating a method 500 that supports adjustment of error correction algorithms in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a plurality of read commands associated with data stored in a plurality of memory arrays of the memory system. In some examples, aspects of the operations of 505 may be performed by a command component 425 as described with reference to FIG. 4.

At 510, the method may include performing, based at least in part on the plurality of read commands and according to a first error correction algorithm, one or more error correction operations on the data. For example, the memory system may use a same first error correction algorithm (e.g., a default error correction algorithm) for multiple read operations during a first duration prior to switching to a second error correction algorithm. Based on using the first error correction algorithm during the first duration, the memory system may determine that the first error correction algorithm is insufficient for correcting errors in the data and may determine that a second error correction algorithm (e.g., with a greater ECC strength) is to be used for subsequent error correction algorithms (e.g., during a second duration after the first duration). In some examples, aspects of the operations of 510 may be performed by an error correction component 430 as described with reference to FIG. 4.

At 515, the method may include storing, based at least in part on a quantity of errors associated with one or more portions of the data detected during the one or more error correction operations being greater than a threshold, metadata that indicates a change from the first error correction algorithm used for the one or more error correction operations to a second error correction algorithm to be used for subsequent access operations associated with the one or more portions of the data. In some examples, aspects of the operations of 515 may be performed by a metadata component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing (e.g., to cause the apparatus to perform) the following aspects of the present disclosure:

Aspect 1: A method, apparatus, or non-transitory computer-readable medium including operations, features, circuitry, logic, means, or instructions, or any combination thereof for receiving a plurality of read commands associated with data stored in a plurality of memory arrays of the memory system; performing, based at least in part on the plurality of read commands and according to a first error correction algorithm, one or more error correction operations on the data; and storing, based at least in part on a quantity of errors associated with one or more portions of the data detected during the one or more error correction operations being greater than a threshold, metadata that indicates a change from the first error correction algorithm used for the one or more error correction operations to a second error correction algorithm to be used for subsequent access operations associated with the one or more portions of the data.

Aspect 2: The method, apparatus, or non-transitory computer-readable medium of aspect 1, further including operations, features, circuitry, logic, means, or instructions, or any combination thereof for transferring, based at least in part on the plurality of read commands, the data from the plurality of memory arrays to a buffer of the memory system, the buffer including error correction circuitry for system-level error correction and performing, by the buffer and using the error correction circuitry, the one or more error correction operations on the data transferred to the buffer.

Aspect 3: The method, apparatus, or non-transitory computer-readable medium of any of aspects 1 through 2, further including operations, features, circuitry, logic, means, or instructions, or any combination thereof for determining, based at least in part on performing the one or more error correction operations, a respective quantity of errors associated with each codeword of a plurality of codewords associated with the data and storing, based at least in part on determining the respective quantity of errors associated with each codeword of the plurality of codewords, second metadata, for each codeword of the plurality of codewords, that indicates whether to maintain the first error correction algorithm for subsequent access operations associated with the plurality of codewords.

Aspect 4: The method, apparatus, or non-transitory computer-readable medium of any of aspects 1 through 3, further including operations, features, circuitry, logic, means, or instructions, or any combination thereof for determining, based at least in part on performing the one or more error correction operations, the quantity of errors associated with the one or more portions of the data, where the one or more portions of the data include one or more codewords associated with the data, where storing the metadata that indicates the change from the first error correction algorithm to the second error correction algorithm for the one or more portions of the data is based at least in part on determining that the quantity of errors associated with each codeword of the one or more codewords is greater than the threshold.

Aspect 5: The method, apparatus, or non-transitory computer-readable medium of any of aspects 1 through 4, further including operations, features, circuitry, logic, means, or instructions, or any combination thereof for storing, based at least in part on a second quantity of errors associated with one or more second portions of the data detected during the one or more error correction operations being greater than a second threshold, second metadata that indicates a second change from the first error correction algorithm used for the one or more error correction operations to a third error correction algorithm to be used for subsequent access operations associated with the one or more second portions of the data, where the third error correction algorithm is associated with more error correction capabilities than the first error correction algorithm and the second error correction algorithm.

Aspect 6: The method, apparatus, or non-transitory computer-readable medium of any of aspects 1 through 5, where the threshold is based at least in part on a first quantity of errors that the first error correction algorithm is capable of correcting within a given portion of data and the second error correction algorithm is capable of correcting a second quantity of errors within a given portion of data, the second quantity being greater than the first quantity based at least in part on one or more additional parity bits associated with the second error correction algorithm.

Aspect 7: The method, apparatus, or non-transitory computer-readable medium of any of aspects 1 through 6, where storing the metadata that indicates the change from the first error correction algorithm to the second error correction algorithm includes operations, features, circuitry, logic, means, or instructions, or any combination thereof for storing one or more additional parity bits with a first quantity of parity bits associated with the first error correction algorithm, where the second error correction algorithm is associated with a second quantity of parity bits greater than the first quantity of parity bits.

Aspect 8: The method, apparatus, or non-transitory computer-readable medium of any of aspects 1 through 7, further including operations, features, circuitry, logic, means, or instructions, or any combination thereof for receiving, after storing the metadata, a read command for at least one portion of the one or more portions of the data; retrieving, from one or more memory arrays of the plurality of memory arrays of the memory system based at least in part on the read command, the at least one portion of the data and the metadata; and performing, based at least in part on the metadata, an error correction operation on the at least one portion of the data according to the second error correction algorithm.

Aspect 9: The method, apparatus, or non-transitory computer-readable medium of any of aspects 1 through 8, where receiving the plurality of read commands includes operations, features, circuitry, logic, means, or instructions, or any combination thereof for receiving the plurality of read commands during a duration associated with a profiling of the memory system, where storing the metadata that indicates the change from the first error correction algorithm to the second error correction algorithm is based at least in part on the duration associated with the profiling of the memory system.

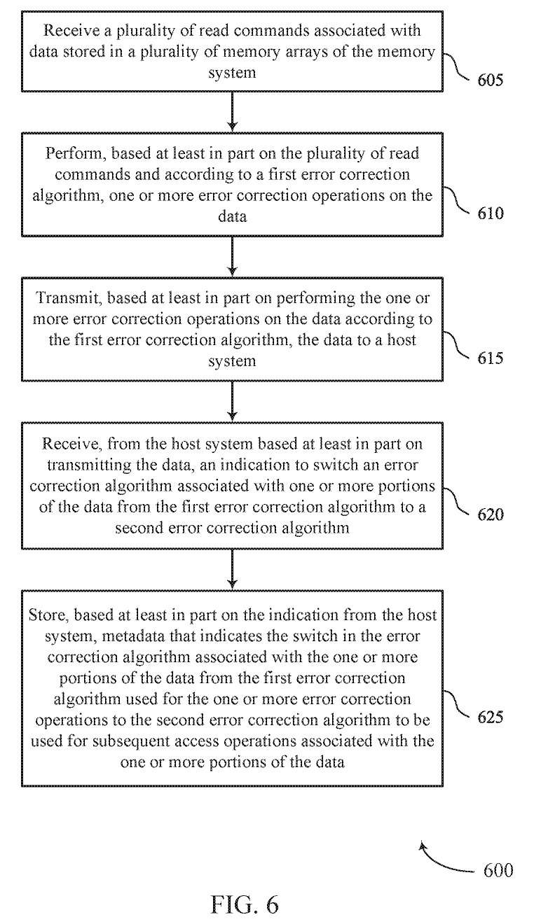

FIG. 6 shows a flowchart illustrating a method 600 that supports adjustment of error correction algorithms in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving a plurality of read commands associated with data stored in a plurality of memory arrays of the memory system. In some examples, aspects of the operations of 605 may be performed by a command component 425 as described with reference to FIG. 4.

At 610, the method may include performing, based at least in part on the plurality of read commands and according to a first error correction algorithm, one or more error correction operations on the data. In some examples, aspects of the operations of 610 may be performed by an error correction component 430 as described with reference to FIG. 4.

At 615, the method may include transmitting, based at least in part on performing the one or more error correction operations on the data according to the first error correction algorithm, the data to a host system. In some examples, aspects of the operations of 615 may be performed by a transmission component 440 as described with reference to FIG. 4.

At 620, the method may include receiving, from the host system based at least in part on transmitting the data, an indication to switch an error correction algorithm associated with one or more portions of the data from the first error correction algorithm to a second error correction algorithm. In some examples, aspects of the operations of 620 may be performed by a reception component 445 as described with reference to FIG. 4.

At 625, the method may include storing, based at least in part on the indication from the host system, metadata that indicates the switch in the error correction algorithm associated with the one or more portions of the data from the first error correction algorithm used for the one or more error correction operations to the second error correction algorithm to be used for subsequent access operations associated with the one or more portions of the data. In some examples, aspects of the operations of 625 may be performed by a metadata component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for receiving a plurality of read commands associated with data stored in a plurality of memory arrays of the memory system; performing, based at least in part on the plurality of read commands and according to a first error correction algorithm, one or more error correction operations on the data; transmitting, based at least in part on performing the one or more error correction operations on the data according to the first error correction algorithm, the data to a host system; receiving, from the host system based at least in part on transmitting the data, an indication to switch an error correction algorithm associated with one or more portions of the data from the first error correction algorithm to a second error correction algorithm; and storing, based at least in part on the indication from the host system, metadata that indicates the switch in the error correction algorithm associated with the one or more portions of the data from the first error correction algorithm used for the one or more error correction operations to the second error correction algorithm to be used for subsequent access operations associated with the one or more portions of the data.

Aspect 11: The method, apparatus, or non-transitory computer-readable medium of aspect 10, further including operations, features, circuitry, logic, means, or instructions, or any combination thereof for transferring, based at least in part on the plurality of read commands, the data from the plurality of memory arrays to a buffer of the memory system, the buffer including error correction circuitry for system-level error correction and performing, by the buffer and using the error correction circuitry, the one or more error correction operations on the data transferred to the buffer.

Aspect 12: The method, apparatus, or non-transitory computer-readable medium of any of aspects 10 through 11, further including operations, features, circuitry, logic, means, or instructions, or any combination thereof for receiving, from the host system based at least in part on transmitting the data, a second indication to switch an error correction algorithm associated with one or more second portions of the data from the first error correction algorithm to a third error correction algorithm and storing, based at least in part on the second indication from the host system, second metadata that indicates the switch from the first error correction algorithm used for the one or more error correction operations to the third error correction algorithm to be used for subsequent access operations associated with the one or more second portions of the data, where the third error correction algorithm is associated with more error correction capabilities than the first error correction algorithm and the second error correction algorithm.

Aspect 13: The method, apparatus, or non-transitory computer-readable medium of any of aspects 10 through 12, where storing the metadata that indicates the switch in the error correction algorithm associated with the one or more portions of the data includes operations, features, circuitry, logic, means, or instructions, or any combination thereof for storing one or more additional parity bits with a first quantity of parity bits associated with the first error correction algorithm, where the second error correction algorithm is associated with a second quantity of parity bits greater than the first quantity of parity bits.

Aspect 14: The method, apparatus, or non-transitory computer-readable medium of any of aspects 10 through 13, further including operations, features, circuitry, logic, means, or instructions, or any combination thereof for receiving, after storing the metadata, a read command for at least one portion of the one or more portions of the data; retrieving, from one or more memory arrays of the plurality of memory arrays of the memory system based at least in part on the read command, the at least one portion of the data and the metadata; and performing, based at least in part on the metadata, an error correction operation on the at least one portion of the data according to the second error correction algorithm.

Aspect 15: The method, apparatus, or non-transitory computer-readable medium of any of aspects 10 through 14, where receiving the plurality of read commands includes operations, features, circuitry, logic, means, or instructions, or any combination thereof for receiving the plurality of read commands during a duration associated with a profiling of the memory system, where storing the metadata that indicates the switch from the first error correction algorithm to the second error correction algorithm is based at least in part on the duration associated with the profiling of the memory system.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 16: A memory system, including: one or more memory arrays configured to store data, where each memory array of the one or more memory arrays is coupled with respective first error correction circuitry configured to correct errors associated with a respective portion of the data stored in each memory array and is coupled with a respective mode register of one or more first mode registers; second error correction circuitry configured to correct errors associated with the data stored within the one or more memory arrays; one or more second mode registers coupled with the second error correction circuitry; and processing circuitry coupled with the one or more memory arrays, the second error correction circuitry, and the one or more second mode registers, where the processing circuitry is configured to: set the one or more second mode registers to a first value and the one or more first mode registers to a second value associated with a first error correction mode of the memory system, the first error correction mode associated with performing error correction operations on the respective portions of the data stored at each memory array of the one or more memory arrays using the respective first error correction circuitry; and set the one or more first mode registers to the first value and the one or more second mode registers to the second value associated with a second error correction mode of the memory system, the second error correction mode associated with performing error correction operations on the data retrieved from any one of the one or more memory arrays using the second error correction circuitry.

Aspect 17: The memory system of aspect 16, where the processing circuitry is further configured to: select an error correction algorithm for the error correction operations, by the second error correction circuitry, on the data retrieved from any of the one or more memory arrays based at least in part on metadata stored in the one or more memory arrays, where selection of the error correction algorithm is further based at least in part on setting the one or more first mode registers to the first value and the one or more second mode registers to the second value associated with the second error correction mode of the memory system.

Aspect 18: The memory system of aspect 17, where the metadata indicates a respective error correction algorithm for each codeword of a plurality of codewords associated with the data retrieved from any of the one or more memory arrays.

Aspect 19: The memory system of any of aspects 16 through 18, where the memory system further includes: a buffer coupled with the second error correction circuitry, where the processing circuitry is further configured to: receive one or more read commands for data stored in the one or more memory arrays; transfer, based at least in part on the one or more read commands, the data from the one or more memory arrays to the buffer; and perform, based at least in part on setting the one or more first mode registers to the first value and the one or more second mode registers to the second value associated with the second error correction mode of the memory system, the error correction operations on the data transferred to the buffer using the second error correction circuitry.

Aspect 20: The memory system of aspect 19, where, to transfer the data from the one or more memory arrays to the buffer, the processing circuitry is configured to: transfer, based at least in part on setting the one or more first mode registers to the first value and the one or more second mode registers to the second value associated with the second error correction mode of the memory system, the data with metadata that indicates a respective error correction algorithm associated with each portion of one or more portions of the data, where performing the error correction operations on the data is in accordance with the respective error correction algorithm indicated via the metadata.

Aspect 21: The memory system of any of aspects 16 through 20, where the memory system further includes: a buffer coupled with the second error correction circuitry, where the processing circuitry is further configured to: receive one or more read commands for data stored in the one or more memory arrays; perform, based at least in part on the one or more read commands and based at least in part on setting the one or more first mode registers to the second value and the one or more second mode registers to the first value, the error correction operations at the one or more memory arrays using the respective first error correction circuitry in accordance with the first error correction mode; and transfer, from the one or more memory arrays to the buffer based at least in part on performing the error correction operations, corrected data.

Aspect 22: The memory system of any of aspects 16 through 21, where the processing circuitry is further configured to: perform, as part of a test operation, one or more access operations to access the data stored in the one or more memory arrays; determine a quantity of errors detected in the data during the one or more access operations; and store, to the one or more memory arrays, the data and metadata that indicates an error correction algorithm to be used for subsequent access operations to the data based at least in part on the quantity of errors and a threshold quantity, where setting values of the one or more first mode registers and the one or more second mode registers is based at least in part on the metadata.

Aspect 23: The memory system of any of aspects 16 through 22, where the processing circuitry is further configured to: perform, as part of a test operation, one or more access operations to access the data stored in the one or more memory arrays; receive, from a host system based at least in part on the one or more access operations, an indication of an error correction algorithm to be used for subsequent access operations to the data; and store, to the one or more memory arrays, the data and metadata that indicates the error correction algorithm to be used for subsequent access operations to the data based at least in part on the indication from the host system, where setting values of the one or more first mode registers and the one or more second mode registers is based at least in part on the metadata.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a plurality of read commands associated with data stored in a plurality of memory arrays of the memory system;
perform, based at least in part on the plurality of read commands and according to a first error correction algorithm, one or more error correction operations on the data; and
store, based at least in part on a quantity of errors associated with one or more portions of the data detected during the one or more error correction operations being greater than a threshold, metadata that indicates a change from the first error correction algorithm used for the one or more error correction operations to a second error correction algorithm to be used for subsequent access operations associated with the one or more portions of the data.

2. The memory system of claim 1, wherein the processing circuitry is further configured to cause the memory system to:
transfer, based at least in part on the plurality of read commands, the data from the plurality of memory arrays to a buffer of the memory system, the buffer comprising error correction circuitry for system-level error correction; and
perform, by the buffer and using the error correction circuitry, the one or more error correction operations on the data transferred to the buffer.

3. The memory system of claim 1, wherein the processing circuitry is further configured to cause the memory system to:
determine, based at least in part on performing the one or more error correction operations, a respective quantity of errors associated with each codeword of a plurality of codewords associated with the data; and
store, based at least in part on determining the respective quantity of errors associated with each codeword of the plurality of codewords, second metadata, for each codeword of the plurality of codewords, that indicates whether to maintain the first error correction algorithm for subsequent access operations associated with the plurality of codewords.

4. The memory system of claim 1, wherein the processing circuitry is further configured to cause the memory system to:
determine, based at least in part on performing the one or more error correction operations, the quantity of errors associated with the one or more portions of the data, wherein the one or more portions of the data comprise one or more codewords associated with the data, wherein storing the metadata that indicates the change from the first error correction algorithm to the second error correction algorithm for the one or more portions of the data is based at least in part on determining that the quantity of errors associated with each codeword of the one or more codewords is greater than the threshold.

5. The memory system of claim 1, wherein the processing circuitry is further configured to cause the memory system to:
store, based at least in part on a second quantity of errors associated with one or more second portions of the data detected during the one or more error correction operations being greater than a second threshold, second metadata that indicates a second change from the first error correction algorithm used for the one or more error correction operations to a third error correction algorithm to be used for subsequent access operations associated with the one or more second portions of the data, wherein the third error correction algorithm is associated with more error correction capabilities than the first error correction algorithm and the second error correction algorithm.

6. The memory system of claim 1, wherein:
the threshold is based at least in part on a first quantity of errors that the first error correction algorithm is capable of correcting within a given portion of data, and
the second error correction algorithm is capable of correcting a second quantity of errors within a given portion of data, the second quantity being greater than the first quantity based at least in part on one or more additional parity bits associated with the second error correction algorithm.

7. The memory system of claim 1, wherein storing the metadata that indicates the change from the first error correction algorithm to the second error correction algorithm comprises the processing circuitry configured to cause the memory system to:
store one or more additional parity bits with a first quantity of parity bits associated with the first error correction algorithm, wherein the second error correction algorithm is associated with a second quantity of parity bits greater than the first quantity of parity bits.

8. The memory system of claim 1, wherein the processing circuitry is further configured to cause the memory system to:
receive, after storing the metadata, a read command for at least one portion of the one or more portions of the data;
retrieve, from one or more memory arrays of the plurality of memory arrays of the memory system based at least in part on the read command, the at least one portion of the data and the metadata; and
perform, based at least in part on the metadata, an error correction operation on the at least one portion of the data according to the second error correction algorithm.

9. The memory system of claim 1, wherein receiving the plurality of read commands comprises the processing circuitry configured to cause the memory system to:
receive the plurality of read commands during a duration associated with a profiling of the memory system, wherein storing the metadata that indicates the change from the first error correction algorithm to the second error correction algorithm is based at least in part on the duration associated with the profiling of the memory system.

10. A memory system, comprising:
one or more memory devices; and
processing circuitry coupled with the one or more memory devices and configured to cause the memory system to:
receive a plurality of read commands associated with data stored in a plurality of memory arrays of the memory system;
perform, based at least in part on the plurality of read commands and according to a first error correction algorithm, one or more error correction operations on the data;
transmit, based at least in part on performing the one or more error correction operations on the data according to the first error correction algorithm, the data to a host system;
receive, from the host system based at least in part on transmitting the data, an indication to switch an error correction algorithm associated with one or more portions of the data from the first error correction algorithm to a second error correction algorithm; and
store, based at least in part on the indication from the host system, metadata that indicates the switch in the error correction algorithm associated with the one or more portions of the data from the first error correction algorithm used for the one or more error correction operations to the second error correction algorithm to be used for subsequent access operations associated with the one or more portions of the data.

11. The memory system of claim 10, wherein the processing circuitry is further configured to cause the memory system to:
transfer, based at least in part on the plurality of read commands, the data from the plurality of memory arrays to a buffer of the memory system, the buffer comprising error correction circuitry for system-level error correction; and
perform, by the buffer and using the error correction circuitry, the one or more error correction operations on the data transferred to the buffer.

12. The memory system of claim 10, wherein the processing circuitry is further configured to cause the memory system to:
receive, from the host system based at least in part on transmitting the data, a second indication to switch an error correction algorithm associated with one or more second portions of the data from the first error correction algorithm to a third error correction algorithm; and
store, based at least in part on the second indication from the host system, second metadata that indicates the switch from the first error correction algorithm used for the one or more error correction operations to the third error correction algorithm to be used for subsequent access operations associated with the one or more second portions of the data, wherein the third error correction algorithm is associated with more error correction capabilities than the first error correction algorithm and the second error correction algorithm.

13. The memory system of claim 10, wherein storing the metadata that indicates the switch in the error correction algorithm associated with the one or more portions of the data comprises the processing circuitry configured to cause the memory system to:
store one or more additional parity bits with a first quantity of parity bits associated with the first error correction algorithm, wherein the second error correction algorithm is associated with a second quantity of parity bits greater than the first quantity of parity bits.

14. The memory system of claim 10, wherein the processing circuitry is further configured to cause the memory system to:
receive, after storing the metadata, a read command for at least one portion of the one or more portions of the data;
retrieve, from one or more memory arrays of the plurality of memory arrays of the memory system based at least in part on the read command, the at least one portion of the data and the metadata; and
perform, based at least in part on the metadata, an error correction operation on the at least one portion of the data according to the second error correction algorithm.

15. The memory system of claim 10, wherein receiving the plurality of read commands comprises the processing circuitry configured to cause the memory system to:
receive the plurality of read commands during a duration associated with a profiling of the memory system, wherein storing the metadata that indicates the switch from the first error correction algorithm to the second error correction algorithm is based at least in part on the duration associated with the profiling of the memory system.

16. A memory system, comprising:
one or more memory arrays configured to store data, wherein each memory array of the one or more memory arrays is coupled with respective first error correction circuitry configured to correct errors associated with a respective portion of the data stored in each memory array and is coupled with a respective mode register of one or more first mode registers;
second error correction circuitry configured to correct errors associated with the data stored within the one or more memory arrays;
one or more second mode registers coupled with the second error correction circuitry; and
processing circuitry coupled with the one or more memory arrays, the second error correction circuitry, and the one or more second mode registers, wherein the processing circuitry is configured to:
set the one or more second mode registers to a first value and the one or more first mode registers to a second value associated with a first error correction mode of the memory system, the first error correction mode associated with performing error correction operations on the respective portions of the data stored at each memory array of the one or more memory arrays using the respective first error correction circuitry; and
set the one or more first mode registers to the first value and the one or more second mode registers to the second value associated with a second error correction mode of the memory system, the second error correction mode associated with performing error correction operations on the data retrieved from any one of the one or more memory arrays using the second error correction circuitry.

17. The memory system of claim 16, wherein the processing circuitry is further configured to:
select an error correction algorithm for the error correction operations, by the second error correction circuitry, on the data retrieved from any of the one or more memory arrays based at least in part on metadata stored in the one or more memory arrays, wherein selection of the error correction algorithm is further based at least in part on setting the one or more first mode registers to the first value and the one or more second mode registers to the second value associated with the second error correction mode of the memory system.

18. The memory system of claim 17, wherein the metadata indicates a respective error correction algorithm for each codeword of a plurality of codewords associated with the data retrieved from any of the one or more memory arrays.

19. The memory system of claim 16, wherein the memory system further comprises:
a buffer coupled with the second error correction circuitry, wherein the processing circuitry is further configured to:
receive one or more read commands for data stored in the one or more memory arrays;
transfer, based at least in part on the one or more read commands, the data from the one or more memory arrays to the buffer; and
perform, based at least in part on setting the one or more first mode registers to the first value and the one or more second mode registers to the second value associated with the second error correction mode of the memory system, the error correction operations on the data transferred to the buffer using the second error correction circuitry.

20. The memory system of claim 19, wherein, to transfer the data from the one or more memory arrays to the buffer, the processing circuitry is configured to:
transfer, based at least in part on setting the one or more first mode registers to the first value and the one or more second mode registers to the second value associated with the second error correction mode of the memory system, the data with metadata that indicates a respective error correction algorithm associated with each portion of one or more portions of the data, wherein performing the error correction operations on the data is in accordance with the respective error correction algorithm indicated via the metadata.

21. The memory system of claim 16, wherein the memory system further comprises:
a buffer coupled with the second error correction circuitry, wherein the processing circuitry is further configured to:
receive one or more read commands for data stored in the one or more memory arrays;
perform, based at least in part on the one or more read commands and based at least in part on setting the one or more first mode registers to the second value and the one or more second mode registers to the first value, the error correction operations at the one or more memory arrays using the respective first error correction circuitry in accordance with the first error correction mode; and
transfer, from the one or more memory arrays to the buffer based at least in part on performing the error correction operations, corrected data.

22. The memory system of claim 16, wherein the processing circuitry is further configured to:
perform, as part of a test operation, one or more access operations to access the data stored in the one or more memory arrays;
determine a quantity of errors detected in the data during the one or more access operations; and
store, to the one or more memory arrays, the data and metadata that indicates an error correction algorithm to be used for subsequent access operations to the data based at least in part on the quantity of errors and a threshold quantity, wherein setting values of the one or more first mode registers and the one or more second mode registers is based at least in part on the metadata.

23. The memory system of claim 16, wherein the processing circuitry is further configured to:
perform, as part of a test operation, one or more access operations to access the data stored in the one or more memory arrays;
receive, from a host system based at least in part on the one or more access operations, an indication of an error correction algorithm to be used for subsequent access operations to the data; and
store, to the one or more memory arrays, the data and metadata that indicates the error correction algorithm to be used for subsequent access operations to the data based at least in part on the indication from the host system, wherein setting values of the one or more first mode registers and the one or more second mode registers is based at least in part on the metadata.
